(19) United States
(12) Patent Application Publication
(10) Pub. No.: US 2018/0246859 A1
(43) Pub. Date: Aug. 30, 2018

(54) REPRESENTING POSITION OF GRAPHICAL USER INTERFACE ELEMENTS WITH HIERARCHICAL IDENTIFIERS

(71) Applicant: Microsoft Technology Licensing, LLC, Redmond, WA (US)

(72) Inventors: Aninda Ray, Sammamish, WA (US); John Giang Nguyen, Redmond, WA (US); Anton Yuriyovych Labunets, Bothell, WA (US); Marius Bogdan Moldovean, Seattle, WA (US)

(21) Appl. No.: 15/441,462

(22) Filed: Feb. 24, 2017

(51) Int. Cl. G06F 17/22; G06F 3/0481

(52) U.S. Cl. CPC G06F 17/2241; G06F 3/0482; G06F 17/2247; G06F 3/04817

(57) ABSTRACT

Technologies related to representing positions of graphical elements in a page through use of hierarchical position identifiers are described. A design canvas represents a page using zones, sections, and subsections, where a zone includes 1-m sections, and a subsection includes 1-p subsections. A position of a graphical element in a subsection is represented as a hierarchical position identifier, in the form of a tuple. The hierarchical position identifier includes an index value for a zone, an index value for a section, and an index value for a subsection. When the page is rendered, the graphical element is positioned in the page based upon its hierarchical position identifier.

### BACKGROUND

Web-based applications currently exist that are configured to allow users in an organization to create pages, wherein the web-based applications allow users in the organization to design a page that is configured to present content germane to the organization to other users. In a non-limiting example, a web-based application can provide a design canvas to a user, wherein the design canvas is a graphical tool configured to facilitate creation (and design) of a page for the organization. More specifically, the design canvas is a graphical tool that can he employed by the user to position one or more graphical elements on a page, wherein a graphical element may he text, an image, a video, a widget, or the like. For instance, the graphical element may be a widget that, when the page is rendered, is configured to retrieve an employee directory for the organization and cause the employee directory to be presented in the page.

Conventional design canvases that are configured to facilitate creation of pages limit where graphical elements can be positioned on a page. For instance, using a conventional design canvas, the user is unable to place two widgets side-by-side. This limitation can lead to aesthetically displeasing pages and suboptimal use of display real-estate.

In addition, once a conventional design canvas is employed to publish a page that includes several graphical elements, it is cumbersome for a user to modify the design of the page. For example, if the user wishes to include a new graphical element in between two existing graphical elements in the page, the design canvas requires the user to delete all graphical elements from the page that are to appear below the desirably inserted graphical element, and then reinsert the graphical elements in the order desired by the user. The same issue exists if the user wishes to re-order graphical elements in the page.

Still further, a conventional design canvas represents positions of graphical elements using defined (X,Y) coordinates, as the design canvas directly embeds the graphical elements in the page. Accordingly, the page is displayed in the same manner regardless of the size of the display window used to display the page (which may cause certain pages is to be presented sub-optimally in some display windows). Therefore, if the user desires that the page be aesthetically pleasing on a relatively small display (such as a display of mobile computing device), the user must design an entirely separate page.

### SUMMARY

The following is a brief summary of subject matter that is described in greater detail herein. This summary is not intended to be limiting as to the scope of the claims.

Described herein are various technologies pertaining to a web-based design canvas, which is a graphical tool that is configured to facilitate creation of pages (e.g., web pages). In an example, the design canvas may be particularly well-suited for creating pages that are internal to an enterprise. In contrast to conventional design canvases, which represent positional information for graphical elements in pages inflexibly (e.g., using static (X,Y) coordinates), the design canvas described herein represents positional information for graphical elements hierarchically. With more particularly, the design canvas models a page using zones, sections, and sub-sections. For instance, the design canvas models a pages as including 1 to n zones, wherein each zone includes 1 to m sections, and each section includes 1 to p subsections. It is to be understood that two zones in the page may include a different number of sections; thus, a first zone may include one section, while a second zone may include four sections. Likewise, different sections can include a different number of sub-sections (e.g., a first section may include two subsections, while a second section may include five subsections). The design canvas further allows a user to customizing size of sections and/or subsections. For instance, a weight can be assigned to a section, wherein a size of the section (e.g., horizontally) is based upon the weight. For instance, when each zone can include up to in sections, a maximum weight that can be given to a section may be m (indicating that the section takes up the entirety of the zone), while the minimum weight may be

$$\frac{1}{m} .$$

Accordingly, a weight assigned to a section in a zone is indicative of the absolute (horizontal) size of the section, as well as the (horizontal) size of the section relative to another section in the zone.

Furthermore, as indicated previously, each section may include p subsections, wherein a size of a graphical element that is placed in a subsection may be based upon the size of the section and a number of other subsections in the section. When a user of the design canvas indicates that a graphical element is to be placed in a particular subsection, the design canvas can represent a position of the graphical element in the page using a hierarchical position identifier, which includes a zone index value, a section index value, and a subsection index value, where these values represent the position of the zone, the section, and the subsection on the page (and relative to other zones, sections, and subsections). Accordingly, when a graphical element is positioned in a first subsection in a first section of a first zone, the design canvas can represent the position of the graphical element using the hierarchical position identifier (1,1,1). Similarly, when a second graphical element is positioned in a first subsection of a second section of the first zone, the design canvas can represent the position of the second graphical element using the hierarchical position identifier (1,2,1).

This approach for representing position of graphical elements in a hierarchical manner has various advantages over approaches utilized by conventional design canvases. Specifically, the design canvas ensures monotonically increasing positional indices for graphical elements, which enables new graphical elements to be easily added to an existing page, and further allows for easy re-ordering of existing graphical elements. For instance, adding a new zone Z_{new} between two existing zones Z₁ and Z2 includes creating a new zone index value, where the new zone index value can be any value between the zone index values assigned to Z₁ and Z₂, and adding it to a positional index for the page. Further, once the page is published, the layout state for the page can be persisted in the following format: [Z1[S1 [W1, W2 . . . ], S2[W1 . . . ]. . . ], Z2 . . . ], where {Z: Zone, S: Section, W:Subsection}. Therefore, when a client computing device renders the page, the layout information can be readily deconstructed. Still further, representing the layout of the page as a forest allows for asymptotically optimal retrieval times of graphical elements, thereby enabling more optimized diffing algorithms to identify what has changed in the page with respect to its layout (e.g., which zones, sections, and/or graphical elements were added or removed from the pages since it was last updated).

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a schematic of an exemplary computing system that facilitates constructing page.

FIG. 2 is a schematic that illustrates an exemplary design canvas.

FIG. 3 is a schematic of another exemplary design canvas,

FIG. 4 is a schematic that illustrates a client computing device rendering a page.

FIG. 5 illustrates a display of the page on a display of a second size.

FIG. 6 is a schematic that illustrates display of the page on a display of a third size.

FIG. 7 is a schematic that illustrates an exemplary system that facilitates ranking pages based upon text in a zone section or subsection of a page.

FIG. 8 is a schematic that illustrates generation of an exemplary snippet.

FIG. 9 is a flow diagram illustrating an exemplary methodology for encoding position of a graphical element on a page in a hierarchical manner.

FIG. 10 is a flow diagram illustrating an exemplary methodology for rendering a page on a display.

FIG. 11 illustrates an exemplary computing system.

### DETAILED DESCRIPTION

Various technologies pertaining to a design canvas that represents position of graphical elements of a page hierarchically are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component,” “module,” and “system” are intended to encompass computer-readable data storage that is encoded with computer-executable instructions that cause certain functionality to be performed when executed by a processor. The computer-executable instructions may include a routine, a function, or the like. It is also to be understood that a component, module, or system may be localized on a single device or distributed across several devices. Further, as used herein, the term “exemplary” is intended to mean serving as an illustration or example of something, and is not intended to indicate a preference.

Described herein are various technologies pertaining to a design canvas that represents positions of graphical elements in a page designed by way of the design canvas hierarchically. The design canvas is a graphical tool that facilitates designing pages, wherein the design canvas models the layout of a page (that is to be designed) based upon zones, sections, and (optionally) subsections. More specifically, the design canvas models a page as including 1-n zones, where each zone includes 1-m sections, and wherein each section includes 1-p subsections. Using this layout, the design canvas represents positions of graphical elements in a page using zone, section, and subsection indices. Therefore, a position of a graphical on the page is represented hierarchically and relative to the positions of other graphical elements on the page. Representing graphical element positions in this manner allows for less cumbersome editing of pages (adding and removing graphical elements) than is possible with conventional design canvases. Further, representing graphical element position hierarchically facilitates flexible presentment of graphical elements in the page over a variety of display window sizes.

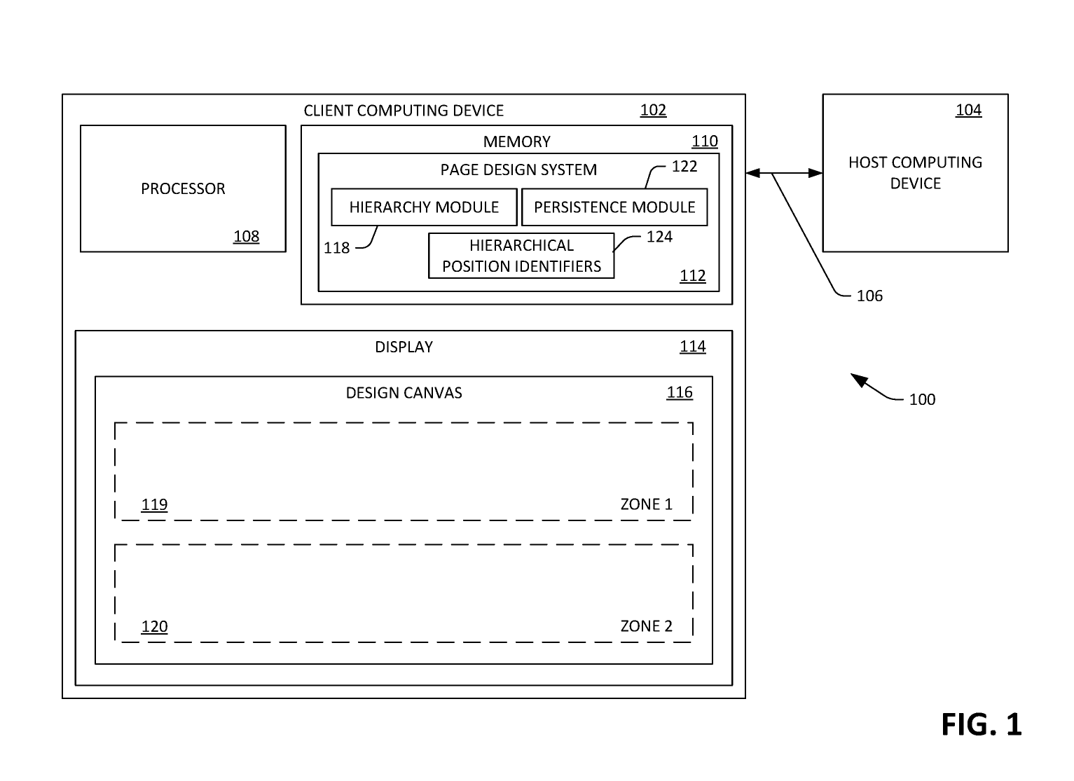

With reference now to FIG. 1, an exemplary system 100 that facilitates designing a computer-implemented page is illustrated. The page can be a web page or other suitable page that is to be presented on a display by way of a computer-executable application (e.g., a web browser or other suitable computer-executable application). The system 100 includes a client computing device 102 in communication with a host computing device 104 by way of a network connection 106. The client computing device 102. includes a processor 108 and memory 110, wherein the memory 110 has a page design system 112 loaded therein. In a non-limiting example, the memory 110 may have a web browser or other web-based application loaded therein, which can be directed to the host computing device 104 (e.g., by way of a uniform resource locator (URL) corresponding to the host computing device 104). The host computing device 104 can then transmit the page design system 112 to client computing device 102, whereupon the page design system 112 is loaded in the memory 110 of the client computing device 102.

The client computing device 102 further includes a display 114, wherein the page design system 112, when executed by the processor 108, can cause a design canvas 116 be presented on the display 114. The page design system 112 includes a hierarchy module 118 that models the layout of a page in a hierarchical manner. For instance, the hierarchy module 118 can model the layout of a page that is to be created by way of the design canvas 116 as including 1 to n zones, wherein each zone includes 1 to m sections, and further wherein each section includes 1 to p subsections. It is to be understood that different zones may include different numbers of sections (e.g., a first zone may include three sections, while a second zone may include five sections). It is to be further understood that different sections can include different numbers of subsections (e.g., a first section may include one subsection, while a second section may include four subsections). As shown in FIG. 1, the design canvas 116 is illustrated as depicting two zones 119 and 120 of a page (with each of the zones 119 and 120 including I to in sections and each of the sections including 1 to p subsections).

The page design system 112 further includes a persistence module 122 that is configured to persist positions of graphical elements (as defined by a user by way of the design canvas 116) using a hierarchical location identifier, Pursuant to an example, a user may set forth input to the design canvas 116 that a first subsection in a first section of the first zone 119 is to include a graphical element, wherein the graphical element may be a widget, a video, an image, text, or the like. The persistence module 122 can represent the position of the graphical element in the page using a tuple (e.g., a triple) of (zone index value, section index value, subsection index value); in this example, the tuple can be (1,1,1).

The user may then set forth to page design system 112 by way of the design canvas 116) that a first subsection in a second section of the first zone 119 is to include a second graphical element. Responsive to receiving such input, the persistence module 122 can represent the position of the second graphical element using the triple (1,2,1). The persistence module 122. can cause these positional representations to be stored in the memory 110 as hierarchical position identifiers 124, wherein each hierarchical position identifier in the hierarchical position identifiers 124 can include an index value for a zone, an index value for a section, and an index value for a subsection. Therefore, when the page is later rendered, each graphical element can be positioned in the page in the zone, section, and subsection represented by its hierarchical position identifier.

Further, as indicated previously, each zone may include 1-m sections, wherein a size of a section in a zone can be defined by a weight assigned to the section. For instance, when a section in a zone is assigned a weight of an, the zone includes a single section and the section takes up the entirety of the zone. Likewise, when a weight of

$$\frac{1}{M}$$

is assigned to a section, there are 1-(m-1) additional sections in the zone. In other words, the section takes up 1/mth of the zone. Likewise, subsections can optionally be assigned weights that indicate sizes of the subsections.

Exemplary operation of the system 100 is now set forth. A user of the client computing device 102 causes the client computing device 102 to execute a web browser, and directs the web browser to the host computing device 104 (which hosts the page design system 112). The host computing device 104 may host an enterprise web application, which can be configured for document storage, page hosting, content structuring, and the like, wherein the page design system 112 is a portion of the enterprise web application. The user of the client computing device 102 can direct the web browser to an address that corresponds the page design system 112. The host computing device 104 transmits the page design system 112 to the client computing device 102 responsive to the web browser being directed to the address that corresponds to the page design system 112 at the host computing device 104.

The page design system 112 is loaded in the memory 110 and, when executed by the processor 108, causes the design canvas 116 to be presented on the display 114. The user of the client computing device 102 may then indicate that a page that is being designed by the user is to include a graphical element, wherein the graphical element is to be positioned in a zone, section, and subsection, as discussed above. The design canvas 116 can support numerous techniques for positioning a graphical element in a subsection of a section of a zone. in an example, the design canvas 116 can graphically depict a zone border, and the user can set forth input that defines a number of sections in the zone, and the number of subsections in each section. The design canvas 116 may then depict borders for the section(s) and subsection(s) of the zone. The user may then selection a subsection (e.g., right click), which can cause a window to be presented, wherein the window can include a plurality of graphical elements that can be displayed in the selected subsection. The user can select a graphical element for presentment in the subsection, and the page design system 112 can represent the position of the graphical element using a hierarchical position identifier. In another example, the design canvas 116 can support drag and drop functionality, where a library of graphical elements is presented, and further wherein the user can select a graphical element from the library and drag it to a desired subsection. Responsive to the graphical element being positioned in the desired subsection, the page design system 112 represents the position of the graphical element using a hierarchical position identifier.

With more particularity, responsive to receiving an indication that the user intends to place the graphical element in the page in the zone, section, and subsection, the persistence module 122 can generate a hierarchical position identifier for the graphical element, wherein the hierarchical position identifier indicates that the graphical element is positioned in the zone, section, and subsection identified by the user. Further, before or after positioning the graphical element in the subsection, the user may set forth input as to a size of the section and/or subsection, and the page design system 112 can assign a weight to the section based upon the input from the user. This process can be repeated for each graphical element that the user indicates is to be included in the page. Once the user has designed the page and the persistence module 122 has represented the positions of the graphical elements in the page using the hierarchical position identifiers 124, the user can indicate to the page design system 112 that the page is to be published. The page design system 112 causes the created page, including the hierarchical position identifiers 124 (or a representation thereof), to be transmitted to the host computing device 104, where the page can be hosted.

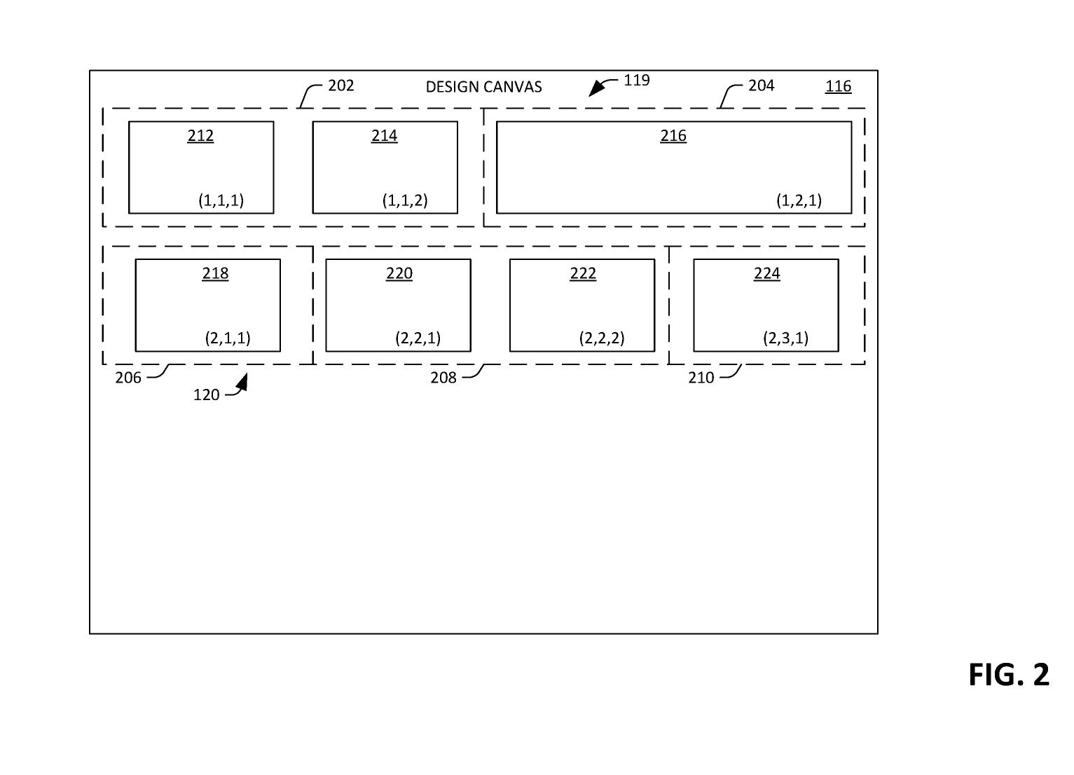

With reference now to FIG. 2, an exemplary schematic of the design canvas 116 is illustrated. In the design canvas 116, the user has indicated that a page to be published that is designed by way of the design canvas 116 is to include the two zones 119 and 120. The first zone 119 includes two sections 202 and 204, and the second zone 120 includes three sections 206, 208, and 210. The first section 202 of the first zone 119 includes two subsections 212 and 214, while the second section 204 of the first zone 119 includes one subsection 216. The first section 206 of the second zone 120 includes one subsection 218, the second section 208 of the second zone 120 includes two subsections 220 and 222, and the third section 210 of the second zone 120 includes one subsection 224. When designing the page by way of the design canvas 116, the user, for example, can indicate that a first graphical element is to be positioned in the subsection 212, a second graphical element is to be positioned in the subsection 214, and so forth.

As shown in FIG. 2, the persistence module 122 can assign hierarchical position identifiers to graphical elements that are positioned in the depicted subsections. For instance, a graphical element positioned in the subsection 212 can be assigned the hierarchical position identifier (1,1,1), wherein a weight

$$\frac{M}{2}$$

is assigned to the section 202 (as the section 202 takes up half of the space of the first zone 119). In another example, a graphical element positioned in the subsection 214 can have the hierarchical position identifier (1,1,2) assigned thereto, wherein the section 202 has a weight of

$$\frac{M}{2}$$

assigned to the section 202. A graphical element positioned in the subsection 216 can have a hierarchical position identifier (1,2,1) assigned thereto, since the graphical element is positioned in the first subsection of the second section of the first zone 119. The section 204 can have a weight of

$$\frac{M}{2}$$

assigned thereto, since the section 204 takes up half of the space of the first zone 119. A graphical element positioned in the subsection 218 can have the hierarchical position identifier (2,1,1) assigned thereto, wherein the section 206 has a weight of

$$\frac{M}{4}$$

assigned thereto, since the section 206 takes up ¼ of the space of the second zone 120. When the user indicates that the page is to be published, the persistence module 122 can serialize the hierarchical position identifiers 124, such that they are in the form [1[1[1,2]], [2[1]]], [2[1[1]], [2[1,2]], [3[1]]]. This format allows for an application, such as a web browser, to deconstruct the layout information when the resultant page is rendered.

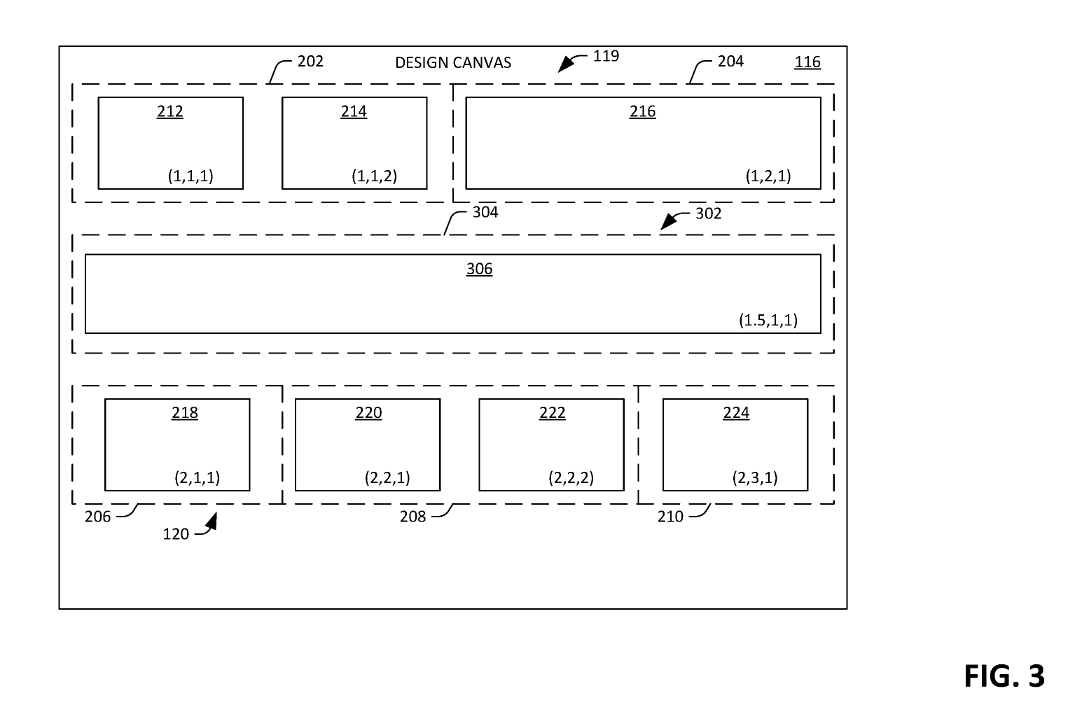

With reference now to FIG. 3, another exemplary depiction of the design canvas 116 is illustrated. FIG. 3 depicts editing of a page to include a third zone 302 between the first zone 119 and the second zone 120. It will be readily understood that the principles described when inserting the third zone 302 in between the first zone 119 and the second zone 120 are also applicable to inserting a new section between existing sections, a new subsection between existing subsections, reordering zones, sections or subsections, etc. Pursuant to an example, the page may have previously been published by way of the design canvas 116. Later, an end-user (which may or may not be the same end-user who published the page) may choose to edit the page through use of the design canvas 300, and indicate that the third zone 302 is to be added on the page and positioned between the first zone 119 and the second zone 120.

Using conventional approaches, if the user wished to place a graphical element between existing graphical elements (as shown in FIG. 3), the user is required to delete all graphical elements that would follow the graphical element that is to be inserted, and subsequently re-insert the deleted graphical elements at the appropriate positions. Using the hierarchical layout approach described herein, the user can indicate that the third zone 302 is to be positioned between the first zone 119 and the second zone 120. The user may then indicate by way the design canvas 116 that the third zone is to include a single section 304, and that the section 304 is to include a single subsection 306. The user may further indicate that a graphical element is to be positioned in the subsection 306.

Responsive to receiving this input from the user, the persistence module 122 can create index values for the zone 302, the section 304, and the subsection 306. The persistence module 122, to preserve the monotonically increasing nature of the hierarchical position identifiers, can generate the index value for the third zone 302 such that the value is between the index for the first zone 119 and the index value for the second zone 120. Thus, if the index value for the first zone 119 is Z₁=1, and the index value for the second zone 120 is Z₂=2, the persistence module 122 can create an index value for the third zone Z₃=(Z₁+Z₂)/2=1.5. Hence, the persistence module 122 can assign a hierarchical position identifier of (1.5,1,1) to the graphical element that is positioned in the subsection 306 of the section 304 of the third zone 302. Further, as indicated in FIG. 3, the section 304 has a weight of in assigned thereto, as the section 304 takes up the entirety of the space of the third zone 302.

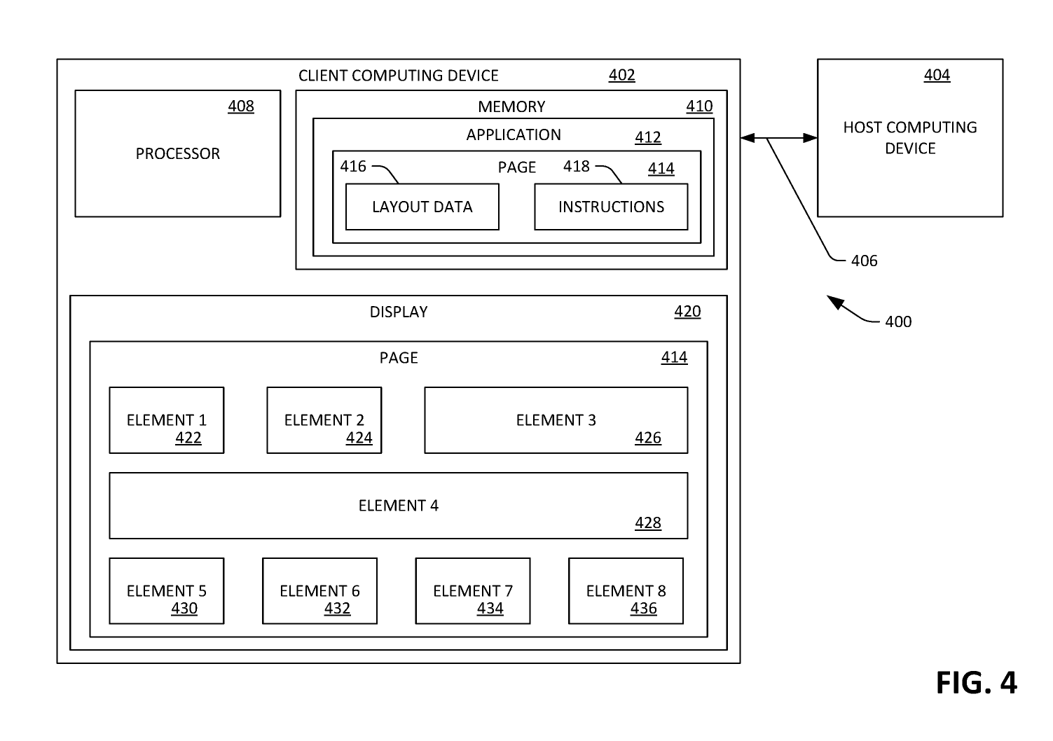

Now referring to FIG. 4, an exemplary system 400 that facilitates rendering the page created by way of the design canvas 116 is illustrated. The system 400 includes a client computing device 402 and a host computing device 404 in communication with one another by way of a network connection 406. While not shown, the host computing device 404 can host the page created by way of the design canvas 116 as shown in FIG. 3. The client computing device 402 may be any suitable type of computing device, including a desktop computing device, laptop computing device, tablet computing device, a mobile telephone, a wearable computing device, etc. The client computing device 402 includes a processor 408 and memory 410, wherein the memory 410 has an application 412 loaded therein. For example, the application 412 can be a web browser, although other types of applications are contemplated.

The user of the client computing device 402 directs the application 412 to retrieve the page hosted at the host computing device 404. The host computing device transmits a page 414 to the client computing device 402, wherein the host computing device 404 transmits layout data 416 and corresponding instructions 418 with the page 414. Thus, while the page 414 is depicted as including the layout data 416 and the instructions 418, it is to be understood that the layout data 416 and the instructions 418 may be considered as being external to the page 414. When the page 414 is received by the client computing device 402, the page 414 is loaded into the memory 410. The layout data 416 is based upon the hierarchical position identifiers 124 for graphical elements in the page, and can have the forest structure noted above (such that the application 412 can deconstruct the layout data 416 to identify the hierarchical position identifiers for each graphical element in the page 414). The instructions 418 are configured to inform to instruct the application 412 as to how to render the page based upon the layout data 416.

The client computing device 402 also includes a display 420, wherein the application 412, when executed by the processor 408 (and based upon the layout data 416 and the instructions 418), causes the page 414 to be rendered on the display 420. The page 414, when displayed on the display 420, includes a plurality of graphical elements 422-436 that are positioned on the page 414 (and are positioned relative to one another) based upon the layout data 416. For example, since the graphical elements 422-426 are reach included in the first zone 119, the graphical elements 422-426 may appear as belonging to a same row in the page 414. Similarly, since the graphical element 428 is in the third zone 302, the graphical element 428 may appear to exist in a different row on the page 414. In FIG. 4, a display window within which the page 414 is displayed is presumed to be somewhat large, so that graphical elements in each zone can be displayed in a same row.

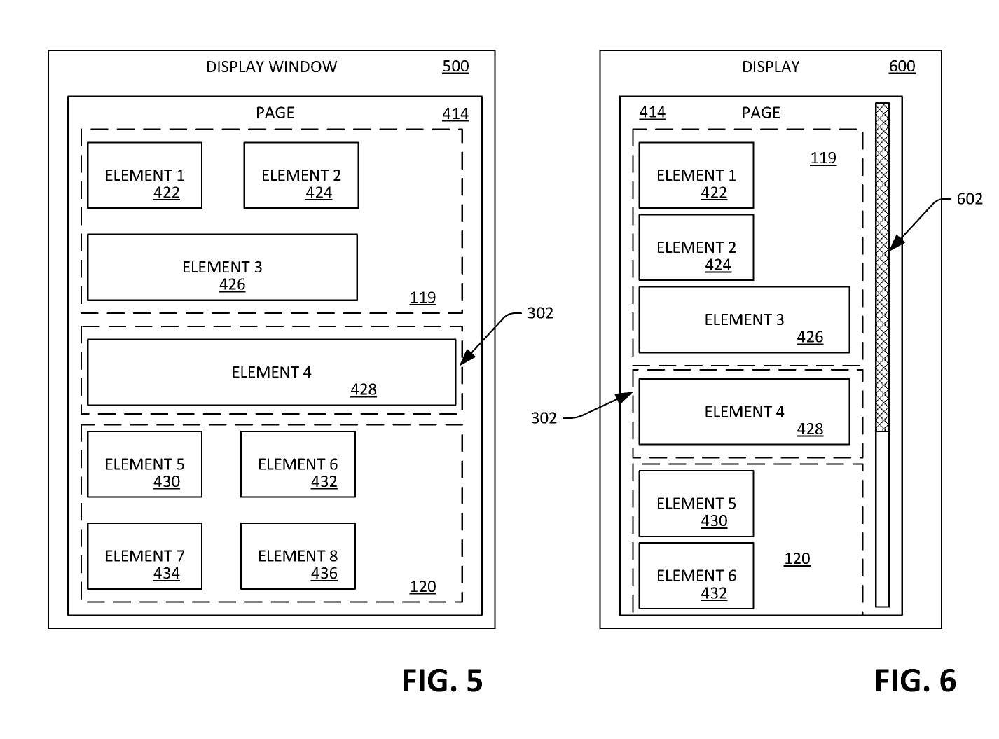

Referring now to FIG. 5, a display window 500 is depicted, wherein the page 414 is shown within the display window 500, and further wherein the display window 500 is narrower than the display window within which the page 414 was shown as being displayed in FIG. 4. For example, the user may have resized the display window to cause the display window to become smaller. In another example, the display window 500 may be shown on a display smaller than the display 420, such as a display for a tablet (slate) computing device.

In an example, the instructions 418 can indicate that a graphical element displayed in a subsection with a width that is less than a width of the display window 500 is to be displayed in its original size, while a graphical element displayed in a subsection with a width that is greater than the width of the display window 500 is to be reduced in size so that an entirety of the graphical element can be shown in the display window 500. In effect, then, in the display window depicted in FIG. 4, a zone and/or section can be perceived as a single row, while in FIG. 5, a zone and/or section can encompass multiple rows (a subsection will not encompass more than one row).

In the example shown in FIG. 5, since the display window 500 has been narrowed (when compared to the display window illustrated in FIG. 4), there is insufficient horizontal space in the display window 500 for the graphical elements 422-426 to be presented in a single row; thus, the zone 119 expands vertically as it is reduced in size horizontally. The application 412 receives width information for the display window 500, and then steps through the layout data 416, using the instructions 418 to position and size the elements 422-436 on the page 414. For example, the application 412 deconstructs the layout data 416 and ascertains that the graphical element 422 is to be positioned in page 414 in accordance with hierarchical position identifier (1,1,1). The application 412 can determine that the width of the display window 500 is greater than the width of the subsection indexed by (1,1,1), and thus renders the graphical element 422 in its full size based upon the hierarchical position identifier (1,1,1). The application 412 turns to hierarchical position identifier (1,1,2), and determines that the width of the display window 500 is greater than the width of the subsection indexed by (1,1,2). The application 412 then ascertains whether the combined widths of the subsections is greater than the width of the display window 500; in this case, the combined width is less than the width of the display window 500, and therefore the graphical element positioned in accordance with the hierarchical position identifier (1,1,2) is rendered in the same row as the graphical element 422.

Continuing with this example, the application 412 then steps to hierarchical position identifier (1,2,1), and determines that a width of the subsection indexed by such identifier is less than a width of the display window 500. Accordingly, the graphical element 426 in such subsection is to be displayed in full size. The application 412, however, can ascertain that the combined widths of the three subsections in the first zone 119 is greater than the width of the display window 500; thus, the application can add a row in the zone 119, and can render the graphical element 426 in this new row. Therefore, instead of the graphical element 426 being depicted beside the graphical element 424 (as shown in FIG. 4), the graphical element 426 is positioned beneath the graphical elements 422 and 424.

The application 412 thereafter steps to the hierarchical positional identifier (2,1,1), and determines that a width of the subsection indexed by such identifier is greater than the width of the display window 500. Thus, the application 412 can shrink the subsection so that its width corresponds to the width of the display window 500. The application 412 can then render the graphical element 428 in the (size-reduced) subsection. The above-described process is repeated for each subsection of the page 414. As depicted, then, a zone and/or section depicted as a single row in one display window can be depicted as multiple rows in another display window. This functionality is enabled as the layout data 416 used by the application 412 to render the page 414 on the display 420 is agnostic of any form factor. Hence, as shown when comparing FIGS. 4 and 5, the layout of the page 414 can dynamically and seamlessly update as the viewport changes. Therefore, in an example, a multicolumn layout in T-wide can be updated to a single column layout in T-narrow.

Now referring to FIG. 6, another exemplary rendering of the page 414 in a display window 500 that is narrower than the display window 600 is illustrated. The page 414 retains all of the graphical elements 422-436 (wherein the graphical elements 434 and 436 are accessible through interaction with a slider 602). As shown, the graphical elements 426 and 428 have been narrowed, since the subsections within which the graphical elements 426 and 428 exist have widths that are greater than the width of the display window 600. Moreover, the graphical elements 422 and 424 are no long displayed beside one another, since the aggregate width of the subsections that include such graphical elements 422 and 424 is greater than the width of the display window 600. Similarly, the graphical elements 430 and 432 are no longer displayed beside one another, as the aggregate width of the subsections that include such elements 430 and 432 is greater than the width of the display window 600. The graphical elements 422, 424, and 430-436 are rendered in their original size (as widths of the subsections that include such elements is less than the width of the display window 600). The ability to alter the layout of the rendered page 414 is possible due to the use of hierarchical position identifiers, rather than inflexible (X,Y) coordinates, when representing position of graphical elements in the page 414.

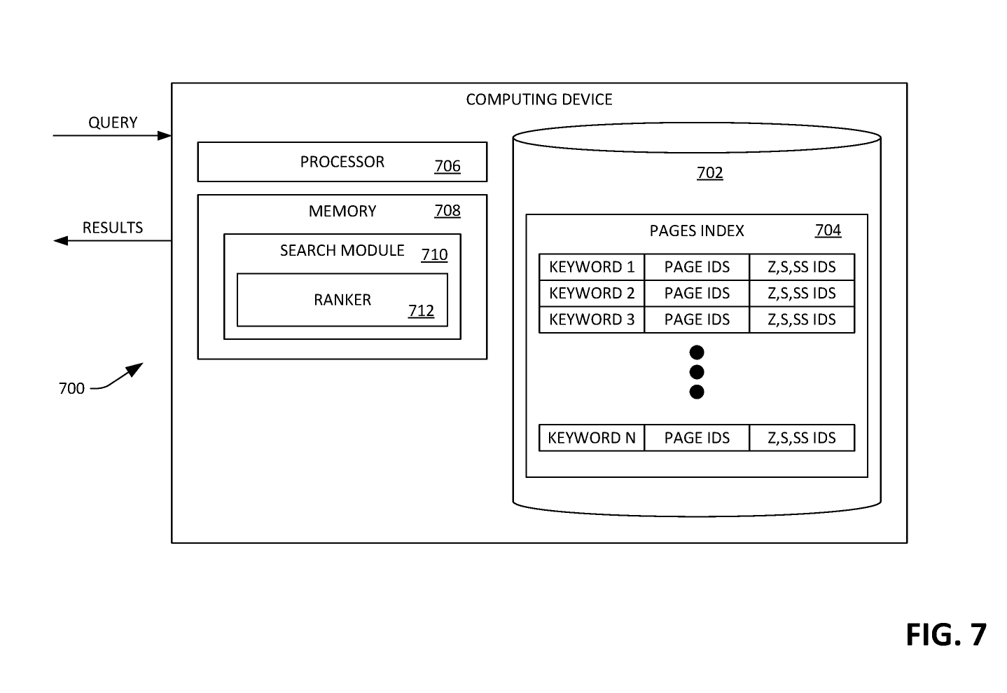

Referring now to FIG. 7, an exemplary computing device 700 that is configured to rank pages relative to one another based upon received queries is illustrated. The computing device 700 includes a data store 702 that comprises a pages index 704. One or more of pages indexed in the pages index 704 can have hierarchical positional data corresponding thereto, as has been described above. Further, zones, sections, and/or subsections of one or more of the pages may have text assigned thereto. For instance, a zone, a section, and/or a subsection may optionally include a title, wherein the title may or may not be set forth for display when the page is rendered. In the pages index 704, a keyword can index one or more pages, and can further index zones, sections, and/or subsections that correspond to the keyword (where such keyword may be included in a title of a zone, section, and/or subsection, where the keyword may be included in content in a zone, section, and/or subsection, etc.), Accordingly, and more specifically, a keyword in the pages index may index a page and may be further mapped to a zone, section, and/or subsection of the page.

The computing device 700 additionally includes a processor 706 and memory 708, wherein the memory 708 has a search module 710 loaded therein, and wherein the search module 710 includes a ranker 712 that is configured to rank pages relative to one another based upon a received query and features of the pages. In an example, the search module 710 can be configured to retrieve pages that are indexed by one or more keywords in the received query. The ranker 712 can ascertain whether the keyword is included in a zone, section, or subsection in the page, and can rank the page relative to other pages based upon the keyword being included in the zone, section, or subsection. For example, the ranker 712 can assign a score to a page based upon a keyword (in the received query) being in a title of a zone, a title of a section, and/or a title of a subsection.

The computing device 700 is than configured to return search results to a computing device from which the query was received. In another example, the computing device 700 can be configured to identify a zone, section, and/or subsection in the page that corresponds to the keyword. When a user of a computing device that receives the search results clicks on a search result, the user can immediately be directed to a zone, section, or subsection that comprises a keyword in the query set forth by the user. In such a case, the application 412, when rendering the page, can utilize the layout data 416 to cause the page to be loaded such that the zone, section, or subsection that includes the keyword set forth in the query is prominently displayed on a display of the computing device employed by the user (e.g., the application 412 automatically scrolls so that the zone, section, or subsection that includes the keyword is centered in the page).

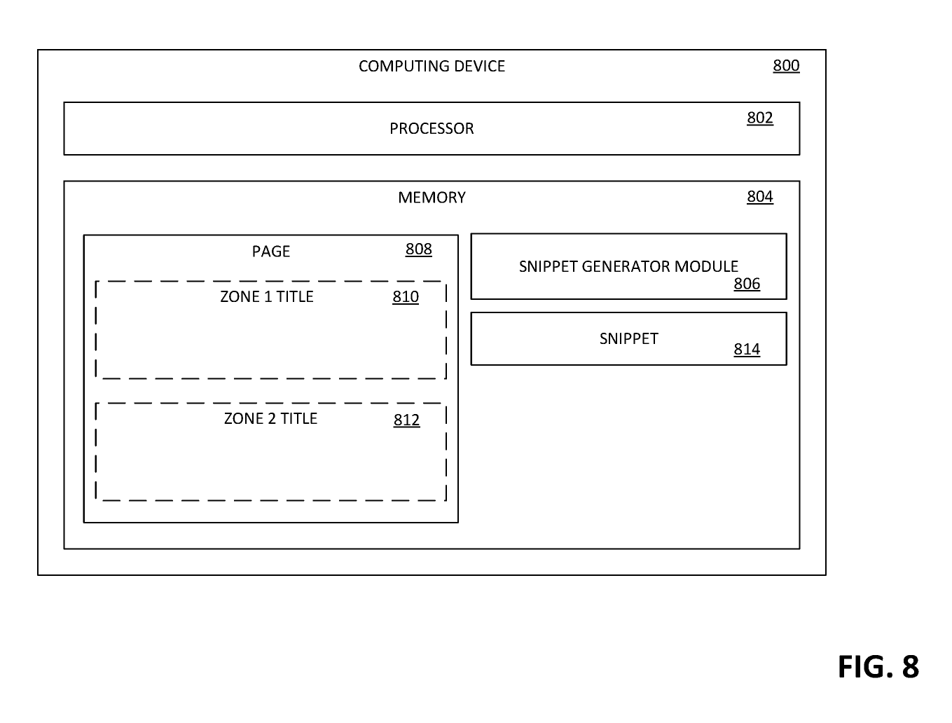

Now referring to FIG. 8, an exemplary computing device 800 that is configured to generate a snippet based upon layout data for a page is illustrated. The computing device 800 includes a processor 802 and memory 804, wherein the memory 804 includes a snippet generator module 806 that is executed by the processor 802. The memory 804 additionally has a page 808 loaded therein, wherein the page has a layout as has been described herein. In the example shown in FIG. 8, the page 808 has a first zone 810 and a second zone 812, wherein the first zone 810 includes a first zone title and the second zone 812 includes a second zone title. The snippet generator module 806 is configured to generate a snippet 814 for the page 808 based upon the layout data for the page 808 and the zone titles for the zones 810 and 812. The snippet 814 includes text and/or imagery extracted from the page 808 that is configured to summarize content of the page 808. As the zone titles are presumably descriptive as to content of graphical elements that are included in the zones 810 and 812, presumably the snippet generator module 806 can generate e snippet 814 utilizing at least portions of these zone titles.

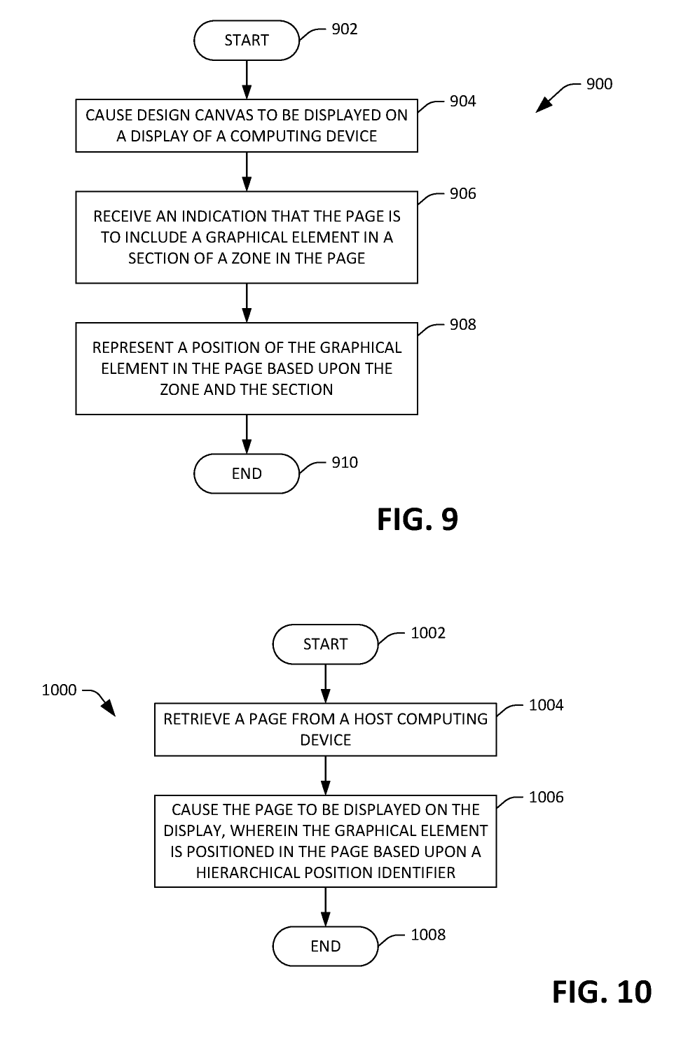

FIGS. 9 and 10 illustrate exemplary methodologies relating to creating and rendering a page, wherein hierarchical position identifiers are employed to represent positions of graphical elements in the page. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Turning now to FIG. 9, an exemplary methodology 900 that facilitates designing a page is illustrated. The methodology 900 starts at 902, and at 904, a design canvas is caused to be displayed on the display of a computing device. As described above, the design canvas is employable to construct (design) a page based upon input from a user of the computing device, wherein the page, when constructed, is to be displayed when a computer-executable application loads the page. Further, as noted above, the design canvas defines a zone on the page and a section that is within the zone.

At 906, an indication is received by way of the design canvas that the page, when constructed, is to include a graphical element in the section, wherein the graphical element is to be displayed in the page when the computer-executable application loads the page. At 908, responsive to receiving such indication, a position of the graphical element is defined in the page based upon the zone and the section, wherein the computer-executable application, when loading the page, positions the graphical element in the page based upon the zone and the section. The methodology 900 completes at 910.

Now referring to FIG. 10, an exemplary methodology 1000 for rendering a page on a display based upon hierarchical layout data for the page is illustrated. The methodology 1000 starts at 1002, and at 1004, a page is retrieved from a host computing device that is in network communication with a computing system that requests the page. The page comprises a graphical element, and a position of the graphical element in the page is defined based upon a hierarchical position identifier for the graphical element. As described previously, the hierarchical position identifier for the graphical element can identify a zone and section (and subsection) within which the graphical is to be displayed. At 1006, responsive to retrieving the page, the page is caused to be displayed on the display, wherein the graphical element is positioned in the page when displayed based upon the hierarchical position identifier. The methodology 1000 completes at 1008.

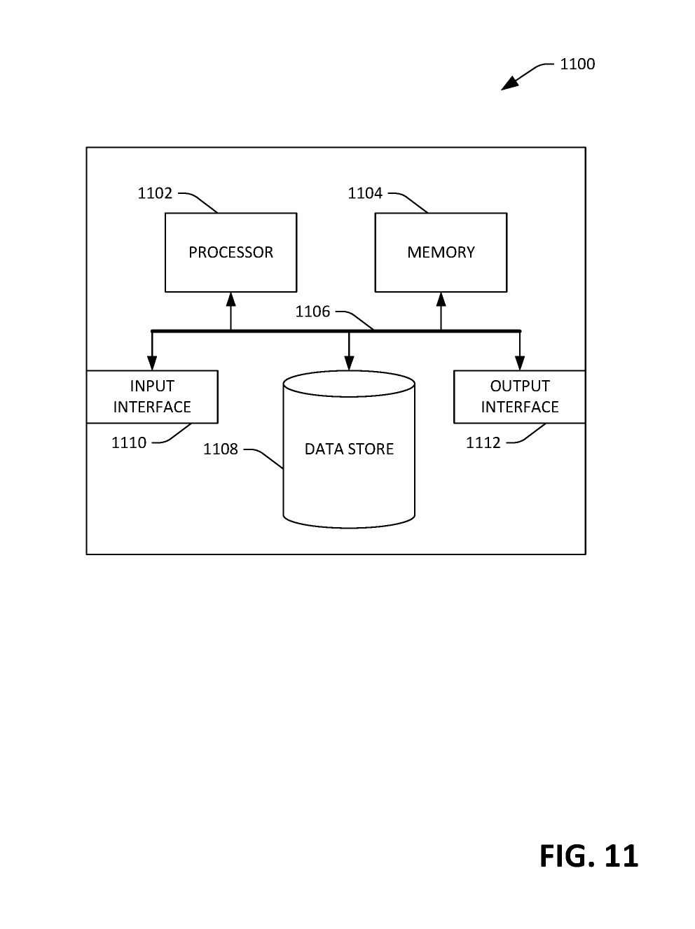

Referring now to FIG. 11, a high-level illustration of an exemplary computing device 1100 that can be used in accordance with the systems and methodologies disclosed herein is illustrated. For instance, the computing device 1100 may be used in a system that supports designing a web page. By way of another example, the computing device 1100 can be used in a system that supports rendering a web page. The computing device 1100 includes at least one processor 1102 that executes instructions that are stored in a memory 1104. The instructions may be, for instance, instructions for implementing functionality described as being carried out by one or more components discussed above or instructions for implementing one or more of the methods described above. The processor 1102 may access the memory 1104 by way of a system bus 1106. In addition to storing executable instructions, the memory 1104 may also store graphical elements, hierarchical position identifiers, etc.

The computing device 1100 additionally includes a data store 1108 that is accessible by the processor 1102 by way of the system bus 1106. The data store 1108 may include executable instructions, graphical elements, hierarchical position identifiers, a pages index, etc. The computing device 1100 also includes an input interface 1110 that allows external devices to communicate with the computing device 1100. For instance, the input interface 1110 may be used to receive instructions from an external computer device, from a user, etc. The computing device 1100 also includes an output interface 1112 that interfaces the computing device 1100 with one or more external devices. For example, the computing device 1100 may display text, images, etc. by way of the output interface 1112.

It is contemplated that the external devices that communicate with the computing device 1100 via the input interface 1110 and the output interface 1112 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1100 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1100 may be a distributed system. Thus, for instance, several devices may be in communication by way of a network connection and may collectively perform tasks described as being performed by the computing device 1100.

Various functions described herein can be implemented in hardware, software, or any combination thereof. If implemented in software, the functions can be stored on or transmitted over as one or more instructions or code on a computer-readable medium. Computer-readable media includes computer-readable storage media A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A method performed by a processor of a computing device, the method comprising:
causing a design canvas to be displayed on a display of the computing device, the design canvas employable to construct a page based upon input from a user of the computing device, wherein the page, when constructed, is to be displayed when a computer-executable application renders the page, and further wherein the design canvas defines a zone on the page and a section within the zone;
receiving, by way of the design canvas, an indication that the page, when constructed, is to include a graphical element in the section, wherein the graphical element is to be displayed in the page when the computer-executable application renders the page; and
responsive to receiving the indication, representing a position of the graphical element in the page with a hierarchical position identifier that identifies the zone and the section, wherein the computer-executable application, when rendering the page, positions the graphical element in the page based upon the hierarchical position identifier.

2. The method of claim 1, wherein the graphical element is a widget.

3. The method of claim 1, wherein the graphical element is one of an image, a video, or text.

4. The method of claim 1, further comprising:
receiving, by way of the design canvas, a section weight that is to be applied to the section, wherein the section weight defines a size of the section relative to sizes of other sections in the zone; and
representing the position of the graphical element in the page based upon the section weight.

5. The method of claim 1, wherein the zone includes a second section, the method further comprising:
receiving, by way of the design canvas, a second indication that the page, when constructed, is to include a second graphical element in the second section, wherein the second graphical element is to be displayed in the page when the computer-executable application renders the page; and
responsive to receiving the second indication, representing a second position of the second graphical element in the page with a second hierarchical position identifier that identifies the zone and the second section, wherein the computer-executable application, when rendering the page, positions the second graphical element in the page based upon the second hierarchical position identifier.

6. The method of claim 1, further comprising:
receiving, by way of the design canvas, a second indication that the page, when constructed, is to include a second graphical element in the section, wherein the second graphical element follows the graphical element in the section, and further wherein the second graphical element is to be displayed in the page when the computer-executable application renders the page; and
responsive to receiving the second indication, representing a second position of the second graphical element in the page with a second hierarchical identifier that identifies the zone, the section, and the section including the graphical element and the second graphical element, and further wherein the computer-executable application, when rendering the page, positions the second graphical element relative to the graphical element based upon the second graphical element following the graphical element in the section.

7. The method of claim 1, wherein the position is encoded as a triple, the triple comprising values that identify:
a location of the zone relative to other zones defined by the design canvas;
a location of the section relative to other sections in the zone; and
a location of the graphical element relative to other graphical elements in the section.

8. The method of claim 1, wherein the design canvas defines a plurality of zones, the method further comprising:
receiving a request to insert the zone between a first zone and a second zone in the design canvas, wherein the first zone has a first numerical index value assigned thereto, and further wherein the second zone has a second numerical index value assigned thereto; and
responsive to receiving the request, inserting the zone between the first zone and the second zone on the design canvas, wherein inserting the zone between the first zone and the second zone comprises assigning a third numerical index value to the zone, the third numerical index value being larger than the first numerical index value and small than the second numerical index value.

9. The method of claim 1, wherein the page is a web page and the computer-executable application is a web browser.

10. A computing system comprising:
a processor; and
memory storing instructions that, when executed by the processor, cause the processor to perform acts comprising:
retrieving a page from a host computing device that is in network communication with the computing system, wherein the page comprises a graphical element, and further wherein a position of the graphical element in the page is defined by a hierarchical position identifier; and
responsive to retrieving the page, causing the page to be displayed on a display, wherein the graphical element is positioned in the page when displayed based upon the hierarchical position identifier.

11. The computing system of claim 10, wherein the graphical element is a widget.

12. The computing system of claim 10, wherein the graphical element is one of an image, video, or text.

13. The computing system of claim 10, wherein the page comprises a zone, the zone includes a section, and the graphical element is in the section, and further wherein the hierarchical position identifier indicates that the graphical element is in the section of the zone.

14. The computing system of claim 13, wherein the hierarchical position identifier further includes a weight for the section, the weight is indicative of a size of the section in the zone.

15. The computing system of claim 13, wherein the section includes a second graphical element, the acts further comprising:
positioning the graphical element in the page relative to the second graphical element based upon a size of the display.

16. The computing system of claim 15, wherein when an aggregate width of subsections in the section that include the graphical elements is less than a width of a display window within which the page is displayed, the graphical element and the second graphical element are displayed beside one another, and further wherein when the aggregate width of the subsections is greater than the width of the display window, the graphical element is displayed above the second graphical element.

17. A computer-readable storage medium comprising instructions that, when executed by a processor, cause the processor to perform acts comprising:
retrieving a page from a host computing device, wherein the page comprises a plurality of zones, a zone in the zones comprises a plurality of sections, a section in the plurality of sections comprises a plurality of subsections, and a subsection in the plurality of subsections includes a graphical element, and further wherein the page comprises a hierarchical position identifier for the graphical element, the hierarchical position identifier includes a first index value for the zone, a second index value for the section, and a third index value for the subsection; and
causing the page to be displayed on a display, wherein the graphical element is displayed at a position on the page based upon the hierarchical position identifier for the graphical element.

18. The computer-readable storage medium of claim 17, wherein a second subsection in the section comprises a second graphical element, the page comprises a second hierarchical position identifier for the second graphical element, the second hierarchical position identifier includes the first index value for the zone, the second index value for the section, and a fourth index value for the second subsection, the acts further comprising causing the graphical element to be positioned relative to the second graphical element in the page based upon the third index value relative to the fourth index value.

19. The computer-readable storage medium of claim 17, wherein a weight value is assigned to the section, wherein a size of the section relative to a second section in the zone is based upon the weight value assigned to the section relative to a second weight value assigned to the second section in the zone.

20. The computer-readable storage medium of claim 17, wherein the graphical element is a widget, and the page is a web page.
